(19) United States
(12) Patent Application Publication
(10) Pub. No.: US 2009/0018176 A1
(43) Pub. Date: Jan. 15, 2009

(54) FUNGICIDE COMPOSITION COMPRISING AN ARYLAMIDINE DERIVATIVE AND TWO KNOWN FUNGICIDE COMPOUNDS

(75) Inventors: Peter Dahmen, Neuss (DE); Thomas Seitz, Langenfeld (DE); Ulrike Wachendorff-Neumann, Neuwied (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Bayer CropScience AG, Monheim Am Rhein (DE)

(21) Appl. No.: 12/063,661

(22) PCT Filed: Sep. 12, 2006
(86) PCT No.: PCT/EP2006/066266

§ 371 Date: Jun. 27, 2008

(30) Foreign Application Priority Data
Sep. 13, 2005 (EP) 05356154.4

(51) Int. Cl. A01N 43/653; A01N 37/52; A01N 43/30; A01P 3/00

(52) U.S. Cl. 514/384; 514/637; 514/383; 514/462

(57) ABSTRACT

The present invention relates to a fungicide composition comprising a N₂-phenylamidine derivative and two other fungicide compounds, at least, as well as and the corresponding methods of protection by application of the said composition. This composition is intended for protecting crops against fungal diseases.

The present invention relates to a fungicide composition intended for protecting crops against fungal diseases, and the corresponding methods of protection by application of the said composition. More precisely, the subject of the present invention is a fungicide composition based on N₂-phenylamidine derivatives and two other fungicide compounds, at least. The fungicide composition according to the invention comprises A) a fungicide N₂-phenylamidine compound; B) a further fungicide compound and C) a further and different fungicide compound. As regards fungicide activity, in particular for the protection of crops, one of the problems at the heart of the research studies carried out in this technical field is the improvement of performances, in particular in terms of fungicide activity and in particular in terms of maintaining this fungicide activity over time.

The fungicide composition useful for the protection of plants against fungi must be endowed with an ecotoxicity which is reduced to the minimum. As far as possible, they should not be dangerous or toxic to the operator during use. The economic factor should of course not be overlooked in the search for novel fungicide compositions.

The fungicide composition according to the invention includes a N₂-phenylamidine derivative as described in international patent application WO-00/46184. These compounds are comprised within the family defined in this international patent application which covers several thousands of compounds including more than 700 compounds explicitly described. As indicated on page 10, lines 16 to 27, of this document, the N₂-phenylamidine derivatives of formula (I) may be incorporated into plant-protection compositions with agriculturally acceptable carriers or diluents and optionally one or more active ingredients, such as for example fungicide compounds. This reference to the use of fungicide compounds with the N₂-phenylamidine compounds of formula (I) has an extremely general scope. The fungicide active compounds which may be combined with the compounds of formula (I) are absolutely not described in the form of isolated compounds or in terms of a chemical family. In particular, no high-performing combination in terms of perennial fungicide activity is disclosed in this international patent application. International patent application WO-03/024219 discloses some mixtures of N₂-phenylamidine compounds with some other fungicide compounds. However none of the partner compounds according to the present invention are disclosed in the said international patent application and only very few of the mixtures disclosed in this publication have led to some experimental tests.

In particular this document does not disclose fungicide compositions including 3 fungicide active compounds at least.

With respect to compounds B or C used in the fungicide composition according to the invention, there are compounds known to the skilled person as possessing an individual fungicide efficacy. The fungicide composition according to the invention can be used for the control of fungi infesting cereals, grapevine, vegetables, potatoes, fruits, lucerne, soybean, industrial crops, market garden crops, turf, wood and horticultural plants, among others.

The present invention advantageously provides a fungicide composition which can be used for controlling all major fungal diseases.

The present invention provides a fungicide composition based on N₂-phenylamidine derivatives which is more active against fungi which are harmful to plants, and which is in particular active over longer periods than the fungicide agents known up until now.

The present invention provides a fungicide composition which is high-performing in particular as regards its efficacy against fungi and the perenniality of this efficacy so as to be able to reduce the doses of chemical products spread in the environment for combating fungal attacks of plants.

The present invention provides a fungicide composition which is more active and provides longer activity, and which therefore has a lower dose, but which is also less toxic, in particular in the preventive and curative treatment of fungal diseases, for example, of cereals, Solanaceae, grapevine, vegetables, lucerne, soyabean, market garden crops, turf, wood or horticultural plants, advantageously on cereals.

The fungicide composition according to the invention may advantageously allow an improvement in the yield of the crops which is significant from an agronomic point of view.

Accordingly, the present invention provides a fungicide composition comprising:

A) an arylamidine derivative of formula (I):

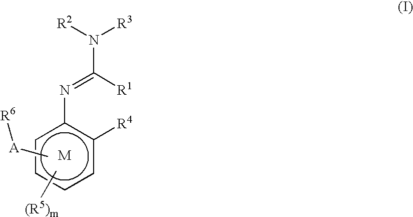

wherein:
R¹ is an alkyl, an alkenyl, an alkynyl, a carbocyclic or heterocyclic monovalent group, it being possible for each of these groups to be substituted, or hydrogen
R² and R³, which may be identical or different, are any one of the groups defined for R¹; a cyano; an acyl; OR^{a} or —SR^{a}, with R^{a} corresponding to an alkyl, an alkenyl, an alkynyl, a carbocyclic or heterocyclic monovalent group, it being possible for each of these groups to be substituted, or R² and R³, or R² and R¹ may form together and with the atoms linking them, a ring which may be substituted;
R⁴ is an alkyl, an alkenyl, an alkynyl, a carbocyclic or heterocyclic monovalent group, it being possible for each of these groups to be substituted, a hydroxyl group; mercapto; azido; nitro; halo; cyano; optionally substituted acyl, amino; cyanato; thiocyanato; —SF₅; —OR^{a}; —SR^{a} or —Si(R^{a})₃;
m=0 to 3;
the optional R⁵ group or the optional R⁵ groups, which may be mutually identical or different, have the same definition as that given above for R⁴;
R⁶ is optionally substituted with a carbocyclic monovalent group; and
A is a direct bond, —O—, —S(O)ₙ—, —NR⁹—, —CR⁷═CR⁷—, —C≡C—, -A¹-, -A¹-A¹, —O-(A¹)ₖ-O—, —O-(A¹)ₖ-, -A³-, -A⁴-, -A¹⁰-, -A¹S(O)ₙ—, -A²-, OA²-, —NR⁹A²-, —OA²-A¹-, —OA²-C(R⁷)═C(R⁸)—, —S(O)ₙA¹-, -A¹-A⁴-, -A¹-A⁴-C(R⁸)═N—N═CR⁸—, -A¹-A⁴-C(R⁸)═N—X²—X³-, -A¹-A⁴-A³-, -A¹-A⁴-N(R⁹)—, -A¹-A⁴-X—CH₂—, -A¹-A⁴-A¹-, -A¹-A⁴-CH₂X—, -A¹-A⁴-C(R⁸)═N—X²—X³—X¹—, A¹-X—C(R⁸)═N—, A¹-X—C(R⁸)═N—N═CR⁸—, -A¹-X—C(R⁸)═N—N(R⁹)—, -A¹-X-A—X¹—, -A¹-O-A³-, -A¹-O—C(R⁷)═C(R⁸)—, -A¹-O—N(R⁹)-A²-N(R⁹)—, -A¹-O—N(R⁹)-A²-, -A¹-N(R⁹)-A²-N(R⁹)—, -A¹-N(R⁹)-A²-, -A¹-N(R⁹)—N═C(R⁸)—,-A³-A¹-, -A⁴-A³-, -A²-NR⁹—, -A¹-A²-X¹—, -A¹-A¹-A²-X¹—, —O-A²-N(R⁹)-A²-, —CR⁷═CR⁷-A²-X¹—, —C≡C-A²-X¹—, —N═C(R⁸)-A²-X¹—, —C(R⁸)═N—N═C(R⁸)—, —C(R⁸)═N—N(R⁹)—, —(CH₂)₂—O—N═C(R⁸)— or —X-A²-N(R⁹)— with
n=0, 1 or 2,
k=1 to 9,
A¹=—CHR⁷—,
A²=—C(═X)—,
A³=—C(R⁸)═N—O—,
A⁴=—O—N═C(R⁸)—,
X═O or S,
X¹=0, S, NR⁹ or a direct bond,
X²=0, NR⁹ or a direct bond,
X³=hydrogen, —C(═O)—, —SO₂— or a direct bond,
R⁷, which are mutually identical or different, each correspond to an optionally substituted alkyl, to a cycloalkyl or a phenyl, it being possible for each of these groups to be substituted, hydrogen, a halogen, a cyano, or an acyl;
R⁸, which are mutually identical or different, each correspond to an alkyl, an alkenyl, an alkynyl, an alkoxy, an alkylthio, it being possible for each of these groups to be substituted, a carbocyclic or heterocyclic monovalent group which may be optionally substituted, or hydrogen;
R⁹, which are mutually identical or different, each correspond to an optionally substituted alkyl, to a monovalent carbocyclic or heterocyclic group which may be optionally substituted, or to an acyl; or two R⁹ groups may form together, and with the atoms linking them, a 5-7-membered ring;
the group represented on the right side of the bond A is linked to R⁶; or -A-R⁶ and R⁵ form together with the benzene ring M, a system of optionally substituted condensed rings;
and the optional optical and/or geometric isomers, the tautomers and the addition salts with an acid or a base, which are agriculturally acceptable, of these derivatives of formula (I); and mixtures thereof;
   B) a fungicide compound selected in the list consisting of
B1) a compound capable to inhibit the nucleic acid synthesis like benalaxyl, benalaxyl-M, bupirimate, chiralaxyl, clozylacon, dimethirimol, ethirimol, furalaxyl, hymexazol, metalaxyl, mefenoxam (formerly metalaxyl-M), ofurace, oxadixyl, oxolinic acid;
B2) a compound capable to inhibit the mitosis and cell division like benomyl, carbendazim, diethofencarb, fuberidazole, pencycuron, thiabendazole thiophanate-methyl, zoxamide;
B3) a compound capable to inhibit the respiration for example
as CI-respiration inhibitor like diflumetorim;
as CII-respiration inhibitor like boscalid, carboxin, fenfuram, flutolanil, furametpyr, mepronil, oxycarboxine, penthiopyrad, thifluzamide;
as CIII-respiration inhibitor like azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin;
B4) a compound capable of to act as an uncoupler like dinocap, fluazinam;
B5) a compound capable to inhibit ATP production like fentin acetate, fentin chloride, fentin hydroxide, silthiofam;
B6) a compound capable to inhibit AA and protein biosynthesis like andoprim, blasticidin-S, cyprodinil, kasugamycin, kasugamycin hydrochloride hydrate, mepanipyrim, pyrimethanil;
B7) a compound capable to inhibit the signal transduction like fenpiclonil, fludioxonil, quinoxyfen;
B8) a compound capable to inhibit lipid and membrane synthesis like chlozolinate, iprodione, procymidone, vinclozolin, pyrazophos, edifenphos, iprobenfos (IBP), isoprothiolane, toldlofos-methyl, biphenyl, iodocarb, propamocarb, propamocarb-hydrochloride, propamocarb-fosetylate also known as dimethyl-[3-(propoxycarbonylamino)propyl]ammonium-O-ethylphosphonate;
B9) a compound capable to inhibit ergosterol biosynthesis like fenhexamid, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulfate, oxpoconazole, fenarimol, flurprimidol, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine, naftifine, pyributicarb, terbinafine;
B10) a compound capable to inhibit cell wall synthesis like benthiavalicarb, bialaphos, dimethomorph, flumorph, iprovalicarb, polyoxins, polyoxorim, validamycin A;
B11) a compound capable to inhibit melanine biosynthesis like carpropamid, diclocymet, fenoxanil, phtalide, pyroquilon, tricyclazole;
B12) a compound capable to induce a host defence like acibenzolar-S-methyl, probenazole, tiadinil;
B13) a compound capable to have a multisite action like captafol, captan, chlorothalonil, copper preparations such as copper hydroxide, copper naphthenate, copper oxychloride, copper sulphate, copper oxide, oxine-copper and Bordeaux mixture, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram-zinc, propineb, sulphur and sulphur preparations including calcium polysulphide, thiram, tolylfluanid, zineb, ziram;
B14) a compound selected in the following list: amisulbrom (formerly amibromdole coded NC-224), benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fosetyl-aluminium, fosetyl-calcium, fosetyl-sodium, fluopicolide, fluoroimide, hexachlorobenzene, 8-hydroxyquinoline sulfate, irumamycin, methasulphocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, phosphorous acid and its salts, piperalin, propanosine-sodium, proquinazid, pyrrolnitrine, quintozene, tecloftalam, tecnazene, triazoxide, trichlamide, zarilamid and 2,3,5,6-tetrachloro-4-(methylsulfonyl)-pyridine, N-(4-chloro-2-nitrophenyl)-N-ethyl-4-methyl-benzenesulfonamide, 2-amino-4-methyl-N-phenyl-5-thiazolecarboxamide, 2-chloro-N-(2,3-dihydro-1,1,3-trimethyl-1H-inden-4-yl)-3-pyridincarboxamide, 3-[5-(4-chlorophenyl)-2,3-dimethylisoxazolidin-3-yl]pyridine, cis-1-(4-chlorophenyl)-2-(1H-1,2,4-trazole-1-yl)-cycloheptanol, methyl 1-(2,3-dihydro-2,2-dimethyl-1H-inden-1-yl)-1H-imidazole-5-carboxylate, 3,4,5-trichloro-2,6-pyridinedicarbonitrile, Methyl 2-[[[cyclopropyl[(4-methoxyphenyl)imino]methyl]thio]methyl]-.alpha.-(methoxymethylene)-benzeneacetate, 4-chloro-alpha-propynyloxy-N-[2-[3-methoxy-4-(2-propynyloxy)phenyl]ethyl]-benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyranon-4-one, N-{(Z)-[(cyclopropylmethoxy)imino][6-(difluoromethoxy)-2,3-difluorophenyl]methyl}-2-phenylacetamide, N-(3-ethyl-3,5,5-trimethyl-cyclohexyl)-3-formylamino-2-hydroxy-benzamide, 2-[[[[1-[3(1-Fluoro-2-phenylethyl)oxy]phenyl]ethylidene]amino]oxy]methyl p-alpha-(methoxyimino)-N-methyl-alphaE-benzeneacetamide, N-(2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, 2-(2-{[6-(3-chloro-2-methylphenoxy)-5-fluoropyrimidin-4-yl]oxy}phenyl)-2-(methoxyimino)-N-methylacetamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, a dipeptic mixture of methyl-[S—(R,S)]-[3-(N-isopropoxycarbonylvalinyl)-amino]-3-(4-chloro-phenyl)propanoate, methyl-(2-chloro-5-{(1E)-N-[(6-methylpyridin-2-yl)methoxy]-ethanimidoyl}benzyl)carbamate, 4-chloro-alpha-methoxy-N-[2-[3-methoxy-4-(2-propynyloxy)phenyl]ethyl]-benzeneacetamide, 3,4-dichloro-N-(2-cyanophenyl)isothiazole-5-carboxamide; and
   C) a further different fungicide compound selected in the list consisting of
C1) a compound capable to inhibit the nucleic acid synthesis like benalaxyl, benalaxyl-M, bupirimate, chiralaxyl, clozylacon, dimethirimol, ethirimol, furalaxyl, hymexazol, metalaxyl, mefenoxam (formerly metalaxyl-M), ofurace, oxadixyl, oxolinic acid;
C2) a compound capable to inhibit the mitosis and cell division like benomyl, carbendazim, diethofencarb, fuberidazole, pencycuron, thiabendazole thiophanate-methyl, zoxamide;
C3) a compound capable to inhibit the respiration for example
as CI-respiration inhibitor like diflumetorim;
as CII-respiration inhibitor like boscalid, carboxin, fenfuram, flutolanil, furametpyr, mepronil, oxycarboxine, penthiopyrad, thifluzamide;
as CIII-respiration inhibitor like azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin;
C4) a compound capable of to act as an uncoupler like dinocap, fluazinam;
C5) a compound capable to inhibit ATP production like fentin acetate, fentin chloride, fentin hydroxide, silthiofam;
C6) a compound capable to inhibit AA and protein biosynthesis like andoprim, blasticidin-S, cyprodinil, kasugamycin, kasugamycin hydrochloride hydrate, mepanipyrim, pyrimethanil;
C7) a compound capable to inhibit the signal transduction like fenpiclonil, fludioxonil, quinoxyfen;
C8) a compound capable to inhibit lipid and membrane synthesis like chlozolinate, iprodione, procymidone, vinclozolin, pyrazophos, edifenphos, iprobenfos (IBP), isoprothiolane, tolclofos-methyl, biphenyl, iodocarb, propamocarb, propamocarb-hydrochloride, propamocarb-fosetylate also known as dimethyl-[3-(propoxycarbonylamino)propyl]ammonium-O-ethylphosphonate;
C9) a compound capable to inhibit ergosterol biosynthesis like fenhexamid, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulfate, oxpoconazole, fenarimol, flurprimidol, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine, naftifine, pyributicarb, terbinafine;
C10) a compound capable to inhibit cell wall synthesis like benthiavalicarb, bialaphos, dimethomorph, flumorph, iprovalicarb, polyoxins, polyoxorim, validamycin A;
C11) a compound capable to inhibit melanine biosynthesis like carpropamid, diclocymet, fenoxanil, phtalide, pyroquilon, tricyclazole;
C12) a compound capable to induce a host defence like acibenzolar-S-methyl, probenazole, tiadinil;
C13) a compound capable to have a multisite action like captafol, captan, chlorothalonil, copper preparations such as copper hydroxide, copper naphthenate, copper oxychloride, copper sulphate, copper oxide, oxine-copper and Bordeaux mixture, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram-zinc, propineb, sulphur and sulphur preparations including calcium polysulphide, thiram, tolylfluanid, zineb, ziram;
C14) a compound selected in the following list: amisulbrom (formerly amibromdole coded NC-224), benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fosetyl-aluminium, fosetyl-calcium, fosetyl-sodium, fluopicolide, fluoroimide, hexachlorobenzene, 8-hydroxyquinoline sulfate, irumamycin, methasulphocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, phosphorous acid and its salts, piperalin, propanosine-sodium, proquinazid, pyrrolnitrine, quintozene, tecloftalam, tecnazene, triazoxide, trichlamide, zarilamid and 2,3,5,6-tetrachloro-4-(methylsulfonyl)-pyridine, N-(4-chloro-2-nitrophenyl)-N-ethyl-4-methyl-benzenesulfonamide, 2-amino-4-methyl-N-phenyl-5-thiazolecarboxamide, 2-chloro-N-(2,3-dihydro-1,1,3-trimethyl-1H-inden-4-yl)-3-pyridincarboxamide, 3-[5-(4-chlorophenyl)-2,3-dimethylisoxazolidin-3-yl]pyridine, cis-1-(4-chlorophenyl)-2-(1H-1,2,4-triazole-1-yl)-cycloheptanol, methyl 1-(2,3-dihydro-2,2-dimethyl-1H-inden-1-yl)-1H-imidazole-5-carboxylate, 3,4,5-trichloro-2,6-pyridinedicarbonitrile, Methyl 2-[[[cyclopropyl[(4-methoxyphenyl)imino]methyl]thio]methyl]-.alpha.-(methoxymethylene)-benzeneacetate, 4-chloro-alpha-propynyloxy-N-[2-[3-methoxy-4-(2-propynyloxy)phenyl]ethyl]-benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyranon-4-one, N-{(Z)-[(cyclopropylmethoxy)imino][6-(difluoromethoxy)-2,3-difluorophenyl]methyl}-2-phenylacetamide, N-(3-ethyl-3,5,5-trimethyl-cyclohexyl)-3-formylamino-2-hydroxy-benzamide, 2-[[[[1-[3(1-Fluoro-2-phenylethyl)oxy]phenyl]ethylidene]amino]oxy]methyl]-alpha-(methoxyimino)-N-methyl-alphaE-benzeneacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, 2-(2-{[6-(3-chloro-2-methylphenoxy)-5-fluoropyrimidin-4-yl]oxy}phenyl)-2-(methoxyimino)-N-methylacetamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, a dipeptic mixture of methyl-[S—(R,S)]-[3-(N-isopropoxycarbonylvalinyl)-amino]-3-(4-chloro-phenyl)propanoate, methyl-(2-chloro-5-{(1E)-N-[(6-methylpyridin-2-yl)methoxy]-ethanimidoyl}benzyl)carbamate, 4-chloro-alpha-methoxy-N-[2-[3-methoxy-4-(2-propynyloxy)phenyl]ethyl]-benzeneacetamide, 3,4-dichloro-N-(2-cyanophenyl)isothiazole-5-carboxamide.

In the definitions of the compound A of formula (I) according to the invention, the various groups, substituents or chemical terms have, unless otherwise stated, the following meanings:
“alkyl or alkyl-” means a linear or branched saturated hydrocarbon radical containing from 1 to 8 carbon atoms;
a “alkenyl” means a linear or branched hydrocarbon radical containing from 1 to 8 carbon atoms and an unsaturation in the form of double bond;
“alkynyl” means a linear or branched hydrocarbon radical containing from 1 to 8 carbon atoms and an insaturation in the form of a triple bond;
“alkoxy” means an alkyloxy radical;
“acyl” means the formyl radical or an alkoxycarbonyl radical;
“cycloalkyl” means a saturated cyclic hydrocarbon radical containing from 3 to 8 carbon atoms;
“aryle” means one or more aromatic radicals, preferably a phenyl or a naphthyl;
“heterocycle” means an unsaturated or a completely or partially saturated cyclic radical containing from 3 to 8 atoms, chosen from carbon, nitrogen, sulphur and oxygen, for example, and without limitation, pyridyl, pyridinyl, quinolyl, furyl, thienyl, pyrrolyl, oxazolinyl;
the term “optionally substituted” means that the radicals thus termed may be substituted with one or more radicals chosen from chlorine, bromine, fluorine, iodine, alkyl, alkoxy, hydroxyl, nitro, amino; cyano and acyl.

Preferred composition 1 according to the invention comprises

A) an arylamidine derivative of formula (I) as previously defined;
B) a fungicide compound selected in the group B1, i.e. a compound capable to inhibit the nucleic acid synthesis like benalaxyl, benalaxyl-M, bupirimate, chiralaxyl, clozylacon, dimethirimol, ethirimol, furalaxyl, hymexazol, metalaxyl, mefenoxam (formerly metalaxyl-M), ofurace, oxadixyl, oxolinic acid; and
C) a further fungicide compound selected in the list consisting of groups C2 to C14 as previously defined.

Preferred composition 2 according to the invention comprises

A) an arylamidine derivative of formula (I) as previously defined;
B) a fungicide compound selected in the group B2, i.e. a compound capable to inhibit the mitosis and cell division like benomyl, carbendazim, diethofencarb, fuberidazole, pencycuron, thiabendazole thiophanate-methyl, zoxamide; and
C) a further fungicide compound selected in the list consisting of groups C1 and C3 to C14 as previously defined.

Preferred composition 3 according to the invention comprises

A) an arylamidine derivative of formula (I) as previously defined;
B) a fungicide compound selected in the group B3, i.e. a compound capable to inhibit the respiration, for example
as CI-respiration inhibitor like diflumetorim;
as CII-respiration inhibitor like boscalid, carboxin, fenfuram, flutolanil, furametpyr, mepronil, oxycarboxine, penthiopyrad, thifluzamide;
as CIII-respiration inhibitor like azoxystrobin, cyazofamid, dimoxystrobin, enestrobin, famoxadone, fenamidone, fluoxastrobin, kresoxim-methyl, metominostrobin, orysastrobin, pyraclostrobin, picoxystrobin, trifloxystrobin; and
   C) a further fungicide compound selected in the list consisting of groups C1, C2 and C4 to C14 as previously defined.

Preferred composition 4 according to the invention comprises

A) an arylamidine derivative of formula (I) as previously defined;
B) a fungicide compound selected in the group B4, i.e. a compound capable of to act as an uncoupler like dinocap, fluazinam; and
C) a further fungicide compound selected in the list consisting of groups C1 to C3 and C5 to C14 as previously defined.

Preferred composition 5 according to the invention comprises

A) an arylamidine derivative of formula (I) as previously defined;
B) a fungicide compound selected in the group B5, i.e. a compound capable to inhibit ATP production like fentin acetate, fentin chloride, fentin hydroxide, silthiofam; and
C) a further fungicide compound selected in the list consisting of groups C1 to C4 and C6 to C14 as previously defined.

Preferred composition 6 according to the invention comprises

A) an arylamidine derivative of formula (I) as previously defined;
B) a fungicide compound selected in the group B6, i.e. a compound capable to inhibit M and protein biosynthesis like andoprim, blasticidin-S, cyprodinil, kasugamycin, kasugamycin hydrochloride hydrate, mepanipyrim, pyrimethanil; and
C) a further fungicide compound selected in the list consisting of groups C1 to C5 and C7 to C14 as previously defined.

Preferred composition 7 according to the invention comprises

A) an arylamidine derivative of formula (I) as previously defined;
B) a fungicide compound selected in the group B7, i.e. a compound capable to inhibit the signal transduction like fenpiclonil, fludioxonil, quinoxyfen; and
C) a further fungicide compound selected in the list consisting of groups C1 to C6 and CB to

C14 as previously defined.

Preferred composition 8 according to the invention comprises A) an arylamidine derivative of formula (I) as previously defined;

B) a fungicide compound selected in the group BB, i.e. a compound capable to inhibit lipid and membrane synthesis like chlozolinate, iprodione, procymidone, vinclozolin, pyrazophos, edifenphos, iprobenfos (IBP), isoprothiolane, toldlofos-methyl, biphenyl, iodocarb, propamocarb, propamocarb-hydrochloride, propamocarb-fosetylate also known as dimethyl-[3-(propoxycarbonylamino)propyl]ammonium-O-ethylphosphonate; and
C) a further fungicide compound selected in the list consisting of groups C1 to C7 and C9 to C14 as previously defined.

Preferred composition 9 according to the invention comprises

A) an arylamidine derivative of formula (I) as previously defined;
B) a fungicide compound selected in the group B9, i.e. a compound capable to inhibit ergosterol biosynthesis like fenhexamid, azaconazole, bitertanol, bromuconazole, cyproconazole, diclobutrazole, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, metconazole, myclobutanil, paclobutrazol, penconazole, propiconazole, prothioconazole, simeconazole, tebuconazole, tetraconazole, triadimefon, triadimenol, triticonazole, uniconazole, voriconazole, imazalil, imazalil sulfate, oxpoconazole, fenarimol, flurprimidol, nuarimol, pyrifenox, triforine, pefurazoate, prochloraz, triflumizole, viniconazole, aldimorph, dodemorph, dodemorph acetate, fenpropimorph, tridemorph, fenpropidin, spiroxamine, naftifine, pyributicarb, terbinafine; and
C) a further fungicide compound selected in the list consisting of groups C1 to C8 and C10 to C14 as previously defined.

Preferred composition 10 according to the invention comprises

A) an arylamidine derivative of formula (I) as previously defined;
B) a fungicide compound selected in the group B10 i.e. a compound capable to inhibit cell wall synthesis like benthiavalicarb, bialaphos, dimethomorph, flumorph, iprovalicarb, polyoxins, polyoxorim, validamycin A; and
C) a further fungicide compound selected in the list consisting of groups C1 to C9 and C11 to C14 as previously defined.

Preferred composition 11 according to the invention comprises

A) an arylamidine derivative of formula (I) as previously defined;
B) a fungicide compound selected in the group B11, i.e. a compound capable to inhibit melanine biosynthesis like carpropamid, diclocymet, fenoxanil, phtalide, pyroquilon, tricyclazole; and
C) a further fungicide compound selected in the list consisting of groups C1 to C10 and C12 to C14 as previously defined.

Preferred composition 12 according to the invention comprises

A) an arylamidine derivative of formula (I) as previously defined;
B) a fungicide compound selected in the group B12, i.e. a compound capable to induce a host defence like acibenzolar-S-methyl, probenazole, tiadinil; and
C) a further fungicide compound selected in the list consisting of groups C1 to C11, C13 and C14 as previously defined.

Preferred composition 13 according to the invention comprises

A) an arylamidine derivative of formula (I) as previously defined;
B) a fungicide compound selected in the group BI 3, i.e. a compound capable to have a multisite action like captafol, captan, chlorothalonil, copper preparations such as copper hydroxide, copper naphthenate, copper oxychloride, copper sulphate, copper oxide, oxine-copper and Bordeaux mixture, dichlofluanid, dithianon, dodine, dodine free base, ferbam, fluorofolpet, folpet, guazatine, guazatine acetate, iminoctadine, iminoctadine albesilate, iminoctadine triacetate, mancopper, mancozeb, maneb, metiram, metiram-zinc, propineb, sulphur and sulphur preparations including calcium polysulphide, thiram, tolylfluanid, zineb, ziram; and
C) a further fungicide compound selected in the list consisting of groups C1 to C12 and C14 as previously defined.

Preferred composition 14 according to the invention comprises

A) an arylamidine derivative of formula (I) as previously defined;
B) a fungicide compound selected in the group B14, i.e. a compound selected in the following list: amisulbrom (formerly amibromdole coded NC-224), benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fosetyl-aluminium, fosetyl-calcium, fosetyl-sodium, fluopicolide, fluoroimide, hexachlorobenzene, 8-hydroxyquinoline sulfate, irumamycin, methasulphocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, phosphorous acid and its salts, piperalin, propanosine-sodium, proquinazid, pyrrolnitrine, quintozene, tecloftalam, tecnazene, triazoxide, trichlamide, zarilamid and 2,3,5,6-tetrachloro-4-(methylsulfonyl)-pyridine, N-(4-chloro-2-nitrophenyl)-N-ethyl-4-methyl-benzenesulfonamide, 2-amino-4-methyl-N-phenyl-5-thiazolecarboxamide, 2-chloro-N-(2,3-dihydro-1,1,3-trimethyl-1H-inden-4-yl)-3-pyridincarboxamide, 3-[5-(4-chlorophenyl)-2,3-dimethylisoxazolidin-3-yl]pyridine, cis-1-(4-chlorophenyl)-2-(1H-1,2,4-triazole-1-yl)-cycloheptanol, methyl 1-(2,3-dihydro-2,2-dimethyl-1H-inden-1-yl)-1H-imidazole-5-carboxylate, 3,4,5-trichloro-2,6-pyridinedicarbonitrile, Methyl 2-[[[cyclopropyl[(4-methoxyphenyl)imino]methyl]thio]methyl]-.alpha.-(methoxymethylene)-benzeneacetate, 4-chloro-alpha-propynyloxy-N-[2-[3-methoxy-4-(2-propynyloxy)phenyl]ethyl]-benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyranon-4-one, N-{(Z)-[(cyclopropylmethoxy)imino][6-(difluoromethoxy)-2,3-difluorophenyl]methyl}-2-phenylacetamide, N-(3-ethyl-3,5,5-trimethyl-cyclohexyl)-3-formylamino-2-hydroxy-benzamide, 2-[[[[1-[3(1-Fluoro-2-phenylethyl)oxy]phenyl]ethylidene]amino]oxy]methyl]-alpha-(methoxyimino)-N-methyl-alphaE-benzeneacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, 2-(2-{[6-(3-chloro-2-methylphenoxy)-5-fluoropyrimidin-4-yl]oxy}phenyl)-2-(methoxyimino)-N-methylacetamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, a dipeptic mixture of methyl-[S—(R,S)]-[3-(N-isopropoxycarbonylvalinyl)-amino]-3-(4-chloro-phenyl)propanoate, methyl-(2-chloro-5-{(1E)-N-[(6-methylpyridin-2-yl)methoxy]-ethanimidoyl}benzyl)carbamate, 4-chloro-alpha-methoxy-N-[2-[3-methoxy-4-(2-propynyloxy)phenyl]ethyl]-benzeneacetamide, 3,4-dichloro-N-(2-cyanophenyl)isothiazole-5-carboxamide; and
C) a further fungicide compound selected in the list consisting of groups C1 to C13 as previously defined.

In the preferred compositions according to the invention, compounds B and C be selected in the same sub-group of compounds provided that they are different. For example, preferred composition 1 according to the invention can combine an arylamidine derivative with compounds B and C selected within sub-groups B1 and C1 respectively. In such a preferred composition 1 according to the invention, compounds B and C must be different.

This applies to preferred compositions 2 to 14 according to the invention.

In the fungicide composition according to the invention, preferred compounds A are compounds of formula (I) wherein:
R¹ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen, or hydrogen;
R² and R³ which may be identical or different and which have the same definition as that given above for R¹ or which correspond to an alkoxy, an alkoxyalkyl, a benzyloxy, a cyano or an alkylcarbonyl;
R⁴ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen; a hydroxyl; a halogen; a cyano; an acyl (preferably: —C(═O)R^{C}, —C(═S)R^{C} or —S(O)ₚR^{C}, with R^{C} corresponding to an alkyl, a haloalkyl, alkoxy, haloalkoxy, alkylthiol, an amine, a monoalkylamine, a dialkylamine or a phenyl optionally substituted with an alkyl, with a haloalkyl, with an alkoxy, with a haloalkoxy, or with an alkylthiol;
m=0 or 1;
when it is present, R⁵ is a group having the same definition as that given above for R⁴,
A is a direct bond, —O—, —S—, —NR⁹—, —CHR⁷— or —O—CHR⁷—,
with R⁹, when it is present, corresponding to an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxyl, with a haloalkoxy, with an alkylthiol or with a halogen, or corresponds to hydrogen;
and R⁷ has the same definition as that given above for R⁹ or represents a hydroxyl; a halogen; a cyano; an acyl; alkoxy; a haloalkoxy or an alkylthiol;
A is linked to the 4-position of the benzyl ring M; and
R⁶ is a phenyl or an aromatic heterocycle, optionally substituted with one or more substituents, which may be identical or different, and which may be selected from the following list: hydroxyl; halogen; cyano; acyl (preferably —C(═O)R^{C}, —C(═S)R^{C} or —S(O)ₚR^{C}, with R^{C}=alkyl, haloalkyl, alkoxy, haloalkoxy, alkylthiol or phenyl optionally substituted with an alkyl, haloalkyl, alkoxy, haloalkoxy or alkylthiol); amine; alkylamine; dialkylamine; alkyl, haloalkyl, R^{a}O-alkyl, acyloxyalkyl, cyanooxyalkyl, alkoxy; haloalkoxy; alkylthiol; cycloalkyl (preferably cyclohexyl or cyclopentyl) optionally substituted with an alkyl, a haloalkyl, an alkoxy, a haloalkoxy or with an alkylthiol; and benzyl optionally substituted with an alkyl, a haloalkyl, an alkoxy, a haloalkoxy or with an alkylthiol.

Compounds A of formula (I) which are particularly preferred possess the following features independently or in combination, preferably in combination:
R¹═H;
R²═C1-C6 alkyl, preferably methyl;
R³═C1-C6 alkyl, preferably ethyl;
R⁴═C1-C6 alkyl, preferably methyl;
R⁵═C1-C6 alkyl, preferably methyl and R⁵ is linked to the carbon at C5 of the benzyl ring M, with m=1;
A is linked to the carbon at C4 of the benzyl ring M and represents —O—;
R⁵=aryl, preferably benzyl, optionally and advantageously substituted with at least one alkyl and/or with at least one halogen.

Compounds A of formula (I) which more are particularly preferred possess the following features independently or in combination, preferably in combination:
R¹═H;
R²=methyl;
R³=ethyl;
R⁴=methyl;
R⁵=methyl and R⁵ is linked to the carbon at C5 of the benzyl ring M, with m=11
A is linked to the carbon at C4 of the benzyl ring M and represents —O—;
R⁶=benzyl substituted with at least one alkyl and/or with at least one halogen.

Preferred compounds A according to the invention are:
N-ethyl-N-methyl-N′-[4-(chloro-3-trifluoromethylphenoxy)-2,5-xylyl]-formamidine,
N-ethyl-N-methyl-N′-[4-(fluoro-3-trifluoromethylphenoxy)-2,5-xylyl]-formamidine,
N-ethyl-N-methyl-N′-[4-(3-t-butyl-4-chlorophenoxy)-2,5-xylyl]-formamidine, and the eventual tautomers and addition salts with an acid or a base, which are agriculturally acceptable, of these compounds A.

The fungicide composition according to the invention allows to significantly improve the persistence of antifungal curative or preventive activity for the treatment of major diseases. This composition may allow eradicant properties which are superior to those of the compounds used alone.

If the compounds in the active compound combinations or compositions according to the invention are present in certain weight ratios, the synergistic effect is particularly pronounced. However, the weight ratios of the active compounds in the active compound combinations or compositions can be varied within a relatively wide range. In general, the active compound combinations or compositions comprise 1 part by weight of the active compound of group A, and from 0.05 to 50 parts, preferably from 0.02 to 20 parts, more preferably from 0.1 to 10 parts of the active compound of group B and from 0.05 to 50 parts, preferably from 0.02 to 20 parts, more preferably from 0.1 to 10 parts of active compound of group C. In addition, they may also comprise further fungicidally active additives. In each case, the mixing ratio is to be chosen such that a synergistic mixture is obtained. The mixing ratios between the compound of the group A and a compound of one of the groups B and C may also vary between the individual compounds within a group.

The fungicide composition according to the invention may further comprise an agriculturally acceptable support, carrier or filler.

According to the invention, the term “support” denotes a natural or synthetic, organic or inorganic compound with which the active compound of formula (I) is combined or associated to make it easier to apply, notably to the parts of the plant. This support is thus generally inert and should be agriculturally acceptable. The support may be a solid or a liquid. Examples of suitable supports include clays, natural or synthetic silicates, silica, resins, waxes, solid fertilisers, water, alcohols, in particular butanol, organic solvents, mineral and plant oils and derivatives thereof. Mixtures of such supports may also be used.

The composition according to the invention may also comprise additional components. In particular, the composition may further comprise a surfactant. The surfactant can be an emulsifier, a dispersing agent or a wetting agent of ionic or non-ionic type or a mixture of such surfactants. Mention may be made, for example, of polyacrylic acid salts, lignosulphonic acid salts, phenolsulphonic or naphthalenesulphonic acid salts, polycondensates of ethylene oxide with fatty alcohols or with fatty acids or with fatty amines, substituted phenols (in particular alkylphenols or arylphenols), salts of sulphosuccinic acid esters, taurine derivatives (in particular alkyl taurates), phosphoric esters of polyoxyethylated alcohols or phenols, fatty acid esters of polyols, and derivatives of the present compounds containing sulphate, sulphonate and phosphate functions. The presence of at least one surfactant is generally essential when the active compound and/or the inert support are water-insoluble and when the vector agent for the application is water. Preferably, surfactant content may be comprised from 5% to 40% by weight of the composition.

Optionally, other additional components may also be included, e.g. protective colloids, adhesives, thickeners, thixotropic agents, penetration agents, stabilisers, sequestering agents. More generally, the active compounds can be combined with any solid or liquid additive, which complies with the usual formulation techniques.

In general, the composition according to the invention may contain from 0.05 to 99% by weight of active compounds, preferably from 10 to 70% by weight.

The compositions according to the invention can be used in various forms such as aerosol dispenser, capsule suspension, cold fogging concentrate, dustable powder, emulsifiable concentrate, emulsion oil in water, emulsion water in oil, encapsulated granule, fine granule, flowable concentrate for seed treatment, gas (under pressure), gas generating product, granule, hot fogging concentrate, macrogranule, microgranule, oil dispersible powder, oil miscible flowable concentrate, oil miscible liquid, paste, plant rodlet, powder for dry seed treatment, seed coated with a pesticide, soluble concentrate, soluble powder, solution for seed treatment, suspension concentrate (flowable concentrate), ultra low volume (ULV) liquid, ultra low volume (ULV) suspension, water dispersible granules or tablets, water dispersible powder for slurry treatment, water soluble granules or tablets, water soluble powder for seed treatment and wettable powder.

These compositions include not only compositions which are ready to be applied to the plant or seed to be treated by means of a suitable device, such as a spraying or dusting device, but also concentrated commercial compositions which must be diluted before application to the crop. The active compounds within the composition according to the invention have potent microbicidal activity and can be used for controlling undesired microorganisms, such as fungi or bacteria, in crop protection or in the protection of materials.

Within the composition according to the invention, fungicide compounds can be used in crop protection for example for controlling Plasmodiophoromycetes, Oomycetes, Chytridiomycetes, Zygomycetes, Ascomycetes, Basidiomycetes and Deuteromycetes.

Within the composition according to the invention, bactericide compounds can be employed in crop protection for example for controlling Pseudomonadaceae, Rhizobiaceae, Enterobacteriaceae, Corynebacteriaceae and Streptomycetaceae.

The fungicide composition according to the invention can be used to curatively or preventively control the phytopathogenic fungi of plants or crops. Thus, according to a further aspect of the invention, there is provided a method for curatively or preventively controlling the phytopathogenic fungi of plants or crops comprising the use of a fungicide composition according to the invention by application to the seed, the plant or to the fruit of the plant or to the soil in which the plant is growing or in which it is desired to grow.

The method of treatment according to the invention may also be useful to treat propagation material such as tubers or rhizomes, but also seeds, seedlings or seedlings pricking out and plants or plants pricking out. This method of treatment can also be useful to treat roots. The method of treatment according to the invention can also be useful to treat the over-ground parts of the plant such as trunks, stems or stalks, leaves, flowers and fruit of the concerned plant. Among the plants that can be protected by the method according to the invention, mention may be made of cereals, grapevine, vegetables, potatoes, fruits, lucerne, soybean, industrial crops, market garden crops, turf, wood and horticultural plants, among others, such as Rosaceae sp. (for instance pip fruit such as apples and pears, but also stone fruit such as apricots, almonds and peaches), Ribesioidae sp., Juglandaceae sp., Betulaceae sp., Anacardiaceae sp., Fagaceae sp., Moraceae sp., Oleaceae sp., Actimidaceae sp., Lauraceae sp., Musaceae sp. (for instance banana trees and plantins), Rubiaceae sp., Theaceae sp., Sterculiceae sp., Rutaceae sp. (for instance lemons, oranges and grapefruit); Solanaceae sp. (for instance tomatoes), Liliaceae sp., Asteraceae sp. (for instance lettuces), Umbelliferae sp., Cruciferae sp., Chenopodiaceae sp., Cucurbitaceae sp., Papilionaceae sp. (for instance peas), Rosaceae sp. (for instance strawberries); major crops such as Graminae sp. (for instance maize, lawn or cereals such as wheat, rice, barley and triticale), Asteraceae sp. (for instance sunflower), Cruciferae sp. (for instance colza), Fabacae sp. (for instance peanuts), Papilionaceae sp. (for instance soybean), Solanaceae sp. (for instance potatoes), Chenopodiaceae sp. (for instance beetroots); horticultural and forest crops; as well as genetically modified homologues of these crops.

Among the diseases of plants or crops that can be controlled by the method according to the invention, mention may be made of:

Powdery mildew diseases such as:
Blumeria diseases, caused for example by Blumeria graminis;
Podosphaera diseases, caused for example by Podosphaera leucotricha;
Sphaerotheca diseases, caused for example by Sphaerotheca fuliginea;
Uncinula diseases, caused for example by Uncinula necator;

Rust diseases such as:
Gymnosporangium diseases, caused for example by Gymnosporangium sabinae;
Hemileia diseases, caused for example by Hemileia vastatrix;
Phakopsora diseases, caused for example by Phakopsora pachyrhizi or Phakopsora meibomiae;
Puccinia diseases, caused for example by Puccinia recondita;
Uromyces diseases, caused for example by Uromyces appendiculatus;

Oomycete diseases such as:
Bremia diseases, caused for example by Bremia lactucae;
Peronospora diseases, caused for example by Peronospora pisi or P. brassicee;
Phytophthora diseases, caused for example by Phytophthora infestans;
Plasmopara diseases, caused for example by Plasmopara viticola;
Pseudoperonospora diseases, caused for example by Pseudoperonospora humuli or Pseudoperonospora cubensis;
Pythium diseases, caused for example by Pythium ultimum;

Leafspot, leaf blotch and leaf blight diseases such as:
Alternaria diseases, caused for example by Alternaria solani;
Cercospora diseases, caused for example by Cercospora beticola;
Cladiosporum diseases, caused for example by Cladiosporium cucumerinum;
Cochliobolus diseases, caused for example by Cochliobolus sativus;
Colletotrichum diseases, caused for example by Colletotrichum lindemuthanium;
Cycloconium diseases, caused for example by Cycloconium oleaginum;
Diaporthe diseases, caused for example by Diaporthe citri;
Elsinoe diseases, caused for example by Elsinoe fawcettii;
Gloeosporium diseases, caused for example by Gloeosporium laeticolor,
Glomerella diseases, caused for example by Glomerella cingulata;
Guignardia diseases, caused for example by Guignardia bidwelli;
Leptosphaeria diseases, caused for example by Leptosphaelia maculans; Leptosphaeria nodorum;
Magnaporthe diseases, caused for example by Magnaporthe grisea;
Mycosphaerella diseases, caused for example by Mycosphaerella graminicola; Mycosphaerella arachidicola; Mycosphaerella fijiensis;
Phaeosphaeria diseases, caused for example by Phaeosphaeria nodorum;
Pyrenophora diseases, caused for example by Pyrenophora teres;
Ramularia diseases, caused for example by Ramularia collo-cygni;
Rhynchosporium diseases, caused for example by Rhynchosporium secalis;
Septoria diseases, caused for example by Septoria apii or Septoria lycopercisi;
Typhula diseases, caused for example by Typhula incamata;
Venturia diseases, caused for example by Venturia inaequalis;

Root and stem diseases such as:
Corticium diseases, caused for example by Corticium graminearum;
Fusarium diseases, caused for example by Fusarium oxysporum;
Gaeumannomyces diseases, caused for example by Gaeumannomyces graminis;
Rhizoctonia diseases, caused for example by Rhizoctonia solani;
Tapesia diseases, caused for example by Tapesia acuformis;
Thielaviopsis diseases, caused for example by Thielaviopsis basicola;

Ear and panicle diseases such as:
Alternaria diseases, caused for example by Alternaria spp.;
Aspergillus diseases, caused for example by Aspergillus flavus;
Cladosporium diseases, caused for example by Cladosporium spp.;
Claviceps diseases, caused for example by Claviceps purpurea;
Fusarium diseases, caused for example by Fusarium culmorum;
Gibberella diseases, caused for example by Gibberella zeae;
Monographella diseases, caused for example by Monographella nivalis;

Smut and bunt diseases such as:
Sphacelotheca diseases, caused for example by Sphacelotheca reiliana;
Tilletia diseases, caused for example by Tilletia caries;
Urocystis diseases, caused for example by Urocystis occulta;
Ustilago diseases, caused for example by Ustilago nuda;

Fruit rot and mould diseases such as:
Aspergillus diseases, caused for example by Aspergillus flavus;
Botrytis diseases, caused for example by Botrytis cinerea;
Penicillium diseases, caused for example by Penicillium expansum;
Sclerotinia diseases, caused for example by Sclerotinia sclerotiorum;
Verticilium diseases, caused for example by Verticilium alboatrum;

Seed and soilborne decay, mould, wilt, rot and damping-off diseases:
Fusarium diseases, caused for example by Fusarium culmorum;
Phytophthora diseases, caused for example by Phytophthora cactorum;
Pythium diseases, caused for example by Pythium ultimum;
Rhizoctonia diseases, caused for example by Rhizoctonia solani;
Scierotium diseases, caused for example by Sclerotium rolfsii;
Microdochium diseases, caused for example by Microdochium nivale;

Canker, broom and dieback diseases such as:
Nectria diseases, caused for example by Nectria galligena;

Blight diseases such as:
Monilinia diseases, caused for example by Monilinia laxa;

Leaf blister or leaf curl diseases such as:
Taphrina diseases, caused for example by Taphrina deformans;

Decline diseases of wooden plants such as:
Esca diseases, caused for example by Phaemoniella clamydospora;
Eutypa dyeback, caused for example by Eutypa lata;
Dutch elm disease, caused for example by Ceratocystis ulmi:

Diseases of flowers and Seeds such as:
Botrytis diseases, caused for example by Botrytis cinerea;
Diseases of tubers such as:
Rhizoctonia diseases, caused for example by Rhizoctonia solani.

The fungicide composition according to the invention may also be used against fungal diseases liable to grow on or inside timber. The term “timber” means all types of species of wood, and all types of working of this wood intended for construction, for example solid wood, high-density wood, laminated wood, and plywood. The method for treating timber according to the invention mainly consists in contacting one or more compounds according to the invention, or a composition according to the invention; this includes for example direct application, spraying, dipping, injection or any other suitable means.

The dose of active compound usually applied in the method of treatment according to the invention is generally and advantageously from 0.1 to 10,000 g/ha, preferably from 10 to 1000 g/ha. For seed dressing, the active-compound combination application rates are generally from 0.001 to 50 g per kilogram of seed, preferably from 0.01 to 10 g per kilogram of seed. For the treatment of the soil, the active-compound combination application rates are generally from 0.1 to 10,000 g/ha, preferably from 1 to 5,000 g/ha.

It is clearly understood that the doses indicated herein are given as illustrative examples of the method according to the invention. A person skilled in the art will know how to adapt the application doses, notably according to the nature of the plant or crop to be treated.

The fungicide composition according to the invention may also be used in the treatment of genetically modified organisms with the compounds according to the invention or the agrochemical compositions according to the invention. Genetically modified plants are plants into genome of which a heterologous gene encoding a protein of interest has been stably integrated. The expression “heterologous gene encoding a protein of interest” essentially means genes which give the transformed plant new agronomic properties, or genes for improving the agronomic quality of the modified plant.

The expression “are applied to the plants to be treated” is understood to mean according to the present invention, that the fungicide composition may be applied by means of various methods of treatment such as:
spraying onto the aerial parts of the said plants a liquid comprising one of the said compositions,
dusting, the incorporation into the soil of granules or powders, spraying, around the said plants, and in the case of trees injection or daubing,
coating or film-coating the seeds of the said plants with the aid of a plant-protection mixture comprising one of the said compositions.

Spraying a liquid onto the aerial parts of the crops to be treated is the preferred method of treatment according to the invention.

The present invention also provides a product comprising a compound A and a compound B and a compound C as a combined preparation for simultaneous, separate or sequential use in controlling the phytopathogenic fungi of crops at a site.

The fungicide composition according to the invention may be prepared immediately before use by using a kit-of-parts for controlling, curatively or preventively, the phytopathogenic fungi of crops, such a kit-of-parts may comprise at least one compound A and at least one compound B as herein defined, intended to be combined or used simultaneously, separately or sequentially in controlling the phytopathogenic fungi of crops at a site.

It is therefore a pack in which the user finds all the ingredients for preparing the fungicide formulation which they wish to apply to the crops. These ingredients, which comprise in particular the active agents A, B and C and which are packaged separately, are provided in the form of a powder or in the form of a liquid which is concentrated to a greater or lesser degree. The user simply has to mix in the prescribed doses and to add the quantities of liquid, for example of water, necessary to obtain a formulation which is ready to use and which can be applied to the crops.

A synergistic effect in fungicide compounds is always present when the fungicidal action of the active compound combinations exceeds the total of the action of the active compounds when applied individually.

The expected fungicidal action for a given combination of two or three active compounds can be calculated as follows, according to S. R. Colby (“Calculating Synergistic and Antagonistic Responses of Herbicide Combinations”, Weeds 1967, 15, 20-22):

If
X is the efficacy when employing active compound A at an application rate of m g/ha,
Y is the efficacy when employing active compound B at an application rate of n g/ha and
Z is the efficacy when employing active compound C at an application rate of r g/ha.
E1 is the efficacy when employing active compounds A and B at application rates of m and n g/ha,
E2 is the efficacy when employing active compounds A and B and C at application rates of m and n and r g/ha,
   then

$${E}_{1} = X + Y - \frac{X \times Y}{100}$$

### (Colby-fungicide)

and for a combination of 3 compounds:

$${E}_{2} = X + Y + Z - \frac{X \times Y - X \times Z - Y \times Z}{100} + \frac{X \times Y \times Z}{10000}$$

Here, the efficacy is determined in %. 0% means an efficacy which corresponds to that of the control, whereas an efficacy of 100% means that no infection is observed.

If the actual fungicidal action exceeds the calculated value, the action of the combination is superadditive, i.e. a synergistic effect is present. In this case, the actually observed efficacy must exceed the value calculated using the above formula for the expected efficacy (E1, E2).

The invention is illustrated by the examples below. However, the invention is not limited to the examples.

### EFFICACY EXAMPLE A

### In Vivo Preventive Test on Puccinia Recondite f. Sp. Tritici (Wheat Brown Rust)

| | |
|---|---|
| Solvent: | 50 parts by weight of N,N-dimethylacetamide |
| Emulsifier: | 1 part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration.

To test for preventive activity, young plants are inoculated with a spore suspension of Puccinia recondita in a 0.1% strength aqueous agar solution. After the spray coating has dried on, the plants are sprayed with the preparation of active compound at the stated rate of application. The plants remain for 24 hours in an incubation cabinet at 20° C. and a relative atmospheric humidity of 100%.

The plants are placed in a greenhouse at a temperature of approximately 20° C. and a relative atmospheric humidity of approximately 80% to promote the development of rust pustules. Evaluation is carried out 12 days after the inoculation. 0% means an efficacy which corresponds to that of the control, whereas an efficacy of 100% means that no infection is observed. Table 1 below shows that the activity found for the active compound combination according to the invention is higher than the calculated activity, i.e. that a synergistic effect is present. Compound 1 according to the invention is N-ethyl-N-methyl-N′-[4-(3-t-butyl-4-chlorphenoxy)-2,5 xylyl]-formamidine.

TABLE 1

| | Calculated | Experimental |
|---|---|---|
| Active compounds (g/ha) | efficacy (%) | efficacy (%) |
| compound 1 (50) | / | 22 |
| tebuconazole (50) | / | 78 |
| spriroxamine (50) | / | 0 |
| compound 1 + tebuconazole (50 + 50) | 83 | 94 |
| compound 1 + spiroxamine (50 + 50) | 22 | 33 |
| compound 1 + spiroxamine + | 83 | 100 |
| tebuconazole (50 + 50 + 50) | | |

### EFFICACY EXAMPLE B

### In Vivo Curative Test on Pyrenophora Teres (Barley)

| | |
|---|---|
| Solvent: | 50 parts by weight of N,N-dimethylacetamide |
| Emulsifier: | 1 part by weight of alkylaryl polyglycol ether |

To produce a suitable preparation of active compound, 1 part by weight of active compound or active compound combination is mixed with the stated amounts of solvent and emulsifier, and the concentrate is diluted with water to the desired concentration. To test for curative activity, young plants are sprayed with a conidia suspension of Pyrenophora teres. The plants remain in an incubation cabinet at 20° C. and 100% relative atmospheric humidity for 48 hours. The plants are then sprayed with the preparation of active compound at the stated application rate.

The plants are placed in a greenhouse at a temperature of about 20° C. and a relative atmospheric humidity of about 80%.

Evaluation is carried out 12 days after the inoculation. 0% means an efficacy which corresponds to that of the control, whereas an efficacy of 100% means that no infection is observed.

Table 2 below shows that the activity found for the active compound combination according to the invention is higher than the calculated activity, i.e. that a synergistic effect is present. Compound 1 according to the invention is N-thyl-N-methyl-N′-[4-(3-t-butyl-4-chlorphenoxy)-2,5-xylyl]-formamidine.

TABLE 2

| | Calculated | Experimental |
|---|---|---|
| Active compounds (g/ha) | efficacy (%) | efficacy (%) |
| compound 1 (50) | / | 0 |
| prothioconazole (50) | / | 0 |
| spriroxamine (50) | / | 50 |
| compound 1 + prothioconazole (50 + | 0 | 17 |
| 50) | | |
| compound 1 + spiroxamine (50 + 50) | 50 | 67 |
| compound 1 + spiroxamine + | 50 | 83 |
| prothioconazole (50 + 50 + 50) | | |

1. A fungicide composition comprising:
A) an arylamidine derivative of formula (I): 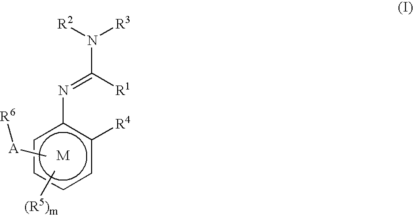
wherein:
R¹ is an alkyl, an alkenyl, an alkynyl, a carbocyclic or heterocyclic monovalent group, it being possible for each of these groups to be substituted, or hydrogen
R² and R³, which may be identical or different, are any one of the groups defined for R¹; a cyano; an acyl; —OR^{a} or —SR^{a}, with R^{a} corresponding to an alkyl, an alkenyl, an alkynyl, a carbocyclic or heterocyclic monovalent group, it being possible for each of these groups to be substituted, or R² and R³, or R² and R¹ may form together and with the atoms linking them, a ring which may be substituted;
R⁴ is an alkyl, an alkenyl, an alkynyl, a carbocyclic or heterocyclic monovalent group, it being possible for each of these groups to be substituted, a hydroxyl group; mercapto; azido; nitro; halo; cyano; optionally substituted acyl, amino; cyanato; thiocyanato; —SF₅; —OR^{a}; —SR^{a} or —Si(R^{a})₃;
m=0 to 3;
the optional R⁵ group or the optional R⁵ groups, which may be mutually identical or different, have the same definition as that given above for R⁴;
R⁶ is optionally substituted with a carbocyclic monovalent group; and
A is a direct bond, —O—, —S(O)ₙ—, —NR⁹—, —CR⁷═CR⁷—, —C≡C—, -A¹-, -A¹-A¹, —O-(A¹)ₖ-O—, —O-(A¹)ₖ-, -A³-, -A⁴-, -A¹⁰-, A¹S(O)ₙ—, -A²-, OA²-, —NR⁹A², —OA²-A¹-, —OA²-C(R⁷)═C(R⁸)—, —S(O)ₙA¹-, -A¹-A⁴-, -A¹-A⁴-C(R⁸)═N—N═CR⁸—, -A¹-A⁴-C(R⁸)═N—X²-X³-, -A¹-A⁴-A³-, -A¹-A⁴-N(R⁹)—, -A¹-A⁴-X—CH₂—, -A¹-A⁴-A¹-, -A¹-A⁴-CH₂X—, -A¹-A⁴-C(R⁸)═N—X²-X³—X¹—, -A¹-X—C(R⁸)═N—, -A¹-X—C(R⁸)═N—N═CR⁸—, -A¹-X—C(R⁸)═N—N(R⁹)—, -A¹-X-A—X¹—, -A¹-O-A³-, -A¹-O—C(R⁷)═C(R⁸)—, -A¹-O—N(R⁹)-A²-N(R⁹)—, -A¹-O—N(R⁹)-A²-, -A¹-N(R⁹)-A²-N(R⁹)—, -A¹-N(R⁹)-A²-, -A¹-N(R⁹)—N═C(R⁸)—, -A³-A¹-, -A⁴-A³-, -A²-NR⁹—, -A¹-A²-X¹—, -A¹-A¹-A²-X¹—, —O-A²-N(R⁹)-A²-, —CR⁷═CR⁷-A²-X¹—, —C≡C-A²-X¹—, —N═C(R⁸)-A²-X¹—, —C(R⁸)═N—N═C(R⁸)—, —C(R⁸)═N—N(R⁹)—, —(CH₂)₂—O—N═C(R⁸)— or —X-A²-N(R⁹)— with
n=0, 1 or 2,
k=1 to 9,
A¹=—CHR⁷—,
A²=—C(═X)—,
A³=—C(R⁸)═N—O—,
A⁴=—O—N═C(R⁸)—,
X═O or S,
X¹═O, S, NR⁹ or a direct bond,
X²=0, NR⁹ or a direct bond,
X³=hydrogen, —C(═O)—, —SO₂— or a direct bond,
R⁷, which are mutually identical or different, each correspond to an optionally substituted alkyl, to a cycloalkyl or a phenyl, it being possible for each of these groups to be substituted, hydrogen, a halogen, a cyano, or an acyl;
R⁸, which are mutually identical or different, each correspond to an alkyl, an alkenyl, an alkynyl, an alkoxy, an alkylthio, it being possible for each of these groups to be substituted, a carbocyclic or heterocyclic monovalent group which may be optionally substituted, or hydrogen;
R⁹, which are mutually identical or different, each correspond to an optionally substituted alkyl, to a monovalent carbocyclic or heterocyclic group which may be optionally substituted, or to an acyl; or two R⁹ groups may form together, and with the atoms linking them, a 5-7-membered ring;
the group represented on the right side of the bond A is linked to R⁶; or -A-R⁶ and R⁵ form together with the benzene ring M, a system of optionally substituted condensed rings;
and the optional optical and/or geometric isomers, the tautomers and the addition salts with an acid or a base, which are agriculturally acceptable, of these derivatives of formula (I); and mixtures thereof;
B) a fungicide compound selected in the list from the group consisting of
B1) a compound capable to inhibit the nucleic acid synthesis;
B2) a compound capable to inhibit the mitosis and cell division;
B3) a compound capable to inhibit the respiration
B4) a compound capable of to act as an uncoupler like dinocap, fluazinam;
B5) a compound capable to inhibit ATP production;
B6) a compound capable to inhibit AA and protein biosynthesis;
B7) a compound capable to inhibit the signal transduction
B8) a compound capable to inhibit lipid and membrane synthesis;
B9) a compound capable to inhibit ergosterol biosynthesis;
B10) a compound capable to inhibit cell wall synthesis;
B11) a compound capable to inhibit melanine biosynthesis;
B12) a compound capable to induce a host defense;
B13) a compound capable to have a multisite action; and
B14) a compound selected from amisulbrom, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fosetyl-aluminium, fosetyl-calcium, fosetyl-sodium, fluopicolide, fluoroimide, hexachlorobenzene, 8-hydroxyquinoline sulfate, irumamycin, methasulphocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, phosphorous acid and its salts, piperalin, propanosine-sodium, proquinazid, pyrrolnitrine, quintozene, tecloftalam, tecnazene, triazoxide, trichlamide, zarilamid and 2,3,5,6-tetrachloro-4-(methylsulfonyl)-pyridine, N-(4-chloro-2-nitrophenyl)-N-ethyl-4-methyl-benzenesulfonamide, 2-amino-4-methyl-N-phenyl-5-thiazolecarboxamide, 2-chloro-N-(2,3-dihydro-1,1,3-trimethyl-1H-inden-4-yl)-3-pyridincarboxamide, 3-[5-(4-chlorophenyl)-2,3-dimethylisoxazolidin-3-yl]pyridine, cis-1-(4-chlorophenyl)-2-(1H-1,2,4-triazole-1-yl)-cycloheptanol, methyl 1-(2,3-dihydro-2,2-dimethyl-1H-inden-1-yl)-1H-imidazole-5-carboxylate, 3,4,5-trichloro-2,6-pyridinedicarbonitrile, Methyl 2-[[[cyclopropyl[(4-methoxyphenyl)imino]methyl]thio]methyl]-.alpha.-(methoxymethylene)-benzeneacetate,
4-chloro-alpha-propynyloxy-N-[2-[3-methoxy-4-(2-propynyloxy)phenyl]ethyl]-benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyranon-4-one, N-{(Z)-[(cyclopropylmethoxy)imino][6-(difluoromethoxy)-2,3-difluorophenyl]methyl}-2-phenylacetamide, N-(3-ethyl-3,5,5-trimethyl-cyclohexyl)-3-formylamino-2-hydroxy-benzamide, 2-[[[[1-[3(1 Fluoro-2-phenylethyl)oxy]phenyl]ethylidene]amino]oxy]methyl]-alpha-(methoxyimino)-N-methyl-alphaE-benzeneacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, 2-(2-{[6-(3-chloro-2-methylphenoxy)-5-fluoropyrimidin-4-yl]oxy}phenyl)-2-(methoxyimino)-N-methylacetamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, a dipeptic mixture of methyl-[S—(R,S)]-[3-(N-isopropoxycarbonylvalinyl)-amino]-3-(4-chloro-phenyl)propanoate, methyl-(2-chloro-5-{(1E)-N-[(6-methylpyridin-2-yl)methoxy]-ethanimidoyl}benzyl)carbamate, 4-chloro-alpha-methoxy-N-[2-[3-methoxy-4-(2-propynyloxy)phenyl]ethyl]-benzeneacetamide, 3,4-dichloro-N-(2-cyanophenyl)isothiazole-5-carboxamide; and
C) a further different fungicide compound selected in the list from the group consisting of
C1) a compound capable to inhibit the nucleic acid synthesis;
C2) a compound capable to inhibit the mitosis and cell division;
C3) a compound capable to inhibit respiration;
C4) a compound capable of to act as an uncoupler;
C5) a compound capable to inhibit ATP production;
C6) a compound capable to inhibit AA and protein biosynthesis;
C7) a compound capable to inhibit the signal transduction;
C8) a compound capable to inhibit lipid and membrane synthesis;
C9) a compound capable to inhibit ergosterol biosynthesis;
C10) a compound capable to inhibit cell wall synthesis;
C11) a compound capable to inhibit melanine biosynthesis;
C12) a compound capable to induce a host defense;
C13) a compound capable to have a multisite action; and
C14) a compound selected from: amisulbrom, benthiazole, bethoxazin, capsimycin, carvone, chinomethionat, chloropicrin, cufraneb, cyflufenamid, cymoxanil, dazomet, debacarb, diclomezine, dichlorophen, dicloran, difenzoquat, difenzoquat methylsulphate, diphenylamine, ethaboxam, ferimzone, flumetover, flusulfamide, fosetyl-aluminium, fosetyl-calcium, fosetyl-sodium, fluopicolide, fluoroimide, hexachlorobenzene, 8-hydroxyquinoline sulfate, irumamycin, methasulphocarb, metrafenone, methyl isothiocyanate, mildiomycin, natamycin, nickel dimethyldithiocarbamate, nitrothal-isopropyl, octhilinone, oxamocarb, oxyfenthiin, pentachlorophenol and salts, 2-phenylphenol and salts, phosphorous acid and its salts, piperalin, propanosine-sodium, proquinazid, pyrrolnitrine, quintozene, tecloftalam, tecnazene, triazoxide, trichlamide, zarilamid and 2,3,5,6-tetrachloro-4-(methylsulfonyl)-pyridine, N-(4-chloro-2-nitrophenyl)-N-ethyl-4-methyl-benzenesulfonamide, 2-amino-4-methyl-N-phenyl-5-thiazolecarboxamide, 2-chloro-N-(2,3-dihydro-1,1,3-trimethyl-1H-inden-4-yl)-3-pyridincarboxamide, 3-[5-(4-chlorophenyl)-2,3-dimethylisoxazolidin-3-yl]pyridine, cis-1-(4-chlorophenyl)-2-(1H-1,2,4-triazole-1-yl)-cycloheptanol, methyl 1-(2,3-dihydro-2,2-dimethyl-1H-inden-1-yl)-1H-imidazole-5-carboxylate, 3,4,5-trichloro-2,6-pyridinedicarbonitrile, Methyl 2-[[[cyclopropyl[(4-methoxyphenyl)imino]methyl]thio]methyl]-.alpha.-(methoxymethylene)-benzeneacetate, 4-chloro-alpha-propynyloxy-N-[2-[3-methoxy-4-(2-propynyloxy)phenyl]ethyl]-benzeneacetamide, (2S)—N-[2-[4-[[3-(4-chlorophenyl)-2-propynyl]oxy]-3-methoxyphenyl]ethyl]-3-methyl-2-[(methylsulfonyl)amino]-butanamide, 5-chloro-7-(4-methylpiperidin-1-yl)-6-(2,4,6-trifluorophenyl)[1,2,4]triazolo[1,5-a]pyrimidine, 5-chloro-6-(2,4,6-trifluorophenyl)-N-[(1R)-1,2,2-trimethylpropyl][1,2,4]triazolo[1,5-a]pyrimidin-7-amine, 5-chloro-N-[(1R)-1,2-dimethylpropyl]-6-(2,4,6-trifluorophenyl)[1,2,4]triazolo[1,5-a]pyrimidin-7-amine, N-[1-(5-bromo-3-chloropyridin-2-yl)ethyl]-2,4-dichloronicotinamide, N-(5-bromo-3-chloropyridin-2-yl)methyl-2,4-dichloronicotinamide, 2-butoxy-6-iodo-3-propyl-benzopyranon-4-one, N-{(Z)-[(cyclopropylmethoxy)imino][6-(difluoromethoxy)-2,3-difluorophenyl]methyl}-2-phenylacetamide, N-(3-ethyl-3,5,5-trimethyl-cyclohexyl)-3-formylamino-2-hydroxy-benzamide, 2-[[[[1-[3(1 Fluoro-2-phenylethyl)oxy]phenyl]ethylidene]amino]oxy]methyl]-alpha-(methoxyimino)-N-methyl-alphaE-benzeneacetamide, N-{2-[3-chloro-5-(trifluoromethyl)pyridin-2-yl]ethyl}-2-(trifluoromethyl)benzamide, N-(3′,4′-dichloro-5-fluorobiphenyl-2-yl)-3-(difluoromethyl)-1-methyl-1H-pyrazole-4-carboxamide, 2-(2-{[6-(3-chloro-2-methylphenoxy)-5-fluoropyrimidin-4-yl]oxy}phenyl)-2-(methoxyimino)-N-methylacetamide, 1-[(4-methoxyphenoxy)methyl]-2,2-dimethylpropyl-1H-imidazole-1-carboxylic acid, O-[1-[(4-methoxyphenoxy)methyl]-2,2-dimethylpropyl]-1H-imidazole-1-carbothioic acid, a dipeptic mixture of methyl-[S—(R,S)]-[3-(N-isopropoxycarbonylvalinyl)-amino]-3-(4-chloro-phenyl)propanoate, methyl-(2-chloro-5-{(1E)-N-[(6-methylpyridin-2-yl)methoxy]-ethanimidoyl}benzyl)carbamate, 4-chloro-alpha-methoxy-N-[2-[3-methoxy-4-(2-propynyloxy)phenyl]ethyl]-benzeneacetamide, 3,4-dichloro-N-(2-cyanophenyl)isothiazole-5-carboxamide.

2. A composition according to claim 1 which is defined as
i) composition 1 which comprises
A) an arylamidine derivative of formula (I);
B) a fungicide compound from; and
C) a further fungicide compound from C2 to C14;
or
ii) composition 2 which comprises
A) an arylamidine derivative of formula (I) as defined in claim 1;
B) a fungicide compound from; and
C) a further fungicide compound from C1 or from C3 to C14;
or
iii) composition 3 which comprises
A) an arylamidine derivative of formula (I);
B) a fungicide compound from B3; and
C) a further fungicide compound from C1, C2 or from and C4 to C14;
or
iv) composition 4 which comprises
A) an arylamidine derivative of formula (I);
B) a fungicide compound selected in the group B4; and
C) a further fungicide compound from C1 to C3 or from C5 to C14;
or
v) composition 5 which comprises
A) an arylamidine derivative of formula (I);
B) a fungicide compound from B5; and
C) a further fungicide compound from C1 to C4 or from and C6 to C14;
or
vi) composition 6 which comprises
A) an arylamidine derivative of formula (I);
B) a fungicide compound from selected B6; and
C) a further fungicide from C1 to C5 or from C7 to C14;
or
vii) composition 7 which comprises
A) an arylamidine derivative of formula (I);
B) a fungicide compound from B7; and
C) a further fungicide compound from C1 to C6 or from C8 to C14;
or
viii) composition 8 which comprises
A) an arylamidine derivative of formula (I);
B) a fungicide compound from B8;
C) a further fungicide from C1 to C7 or from C9 to C14;
or
ix) composition 9 which comprises
A) an arylamidine derivative of formula (I);
B) a fungicide compound from B9; and
C) a further fungicide compound from C1 to C8 or from C10 to C14;
or
x) composition 10 which comprises
A) an arylamidine derivative of formula (I);
B) a fungicide compound from B101; and
C) a further fungicide compound from C1 to C9 or from C11 to C14;
or
xi) composition 11 which comprises
A) an arylamidine derivative of formula (I);
B) a fungicide compound from B11; and
C) a further fungicide compound from C1 to C10 or from C12 to C14;
or
xii) composition 12 which comprises
A) an arylamidine derivative of formula (I);
B) a fungicide compound from B12; and
C) a further fungicide compound from C1 to C11, C13 or from C14;
or
xiii) composition 13 which comprises
A) an arylamidine derivative of formula (I);
B) a fungicide compound from B13; and
C) a further fungicide compound from C1 to C12 or from C14;
or
xiv) composition 14 which comprises
A) an arylamidine derivative of formula (I);
B) a fungicide compound from B14; and
C) a further fungicide compound from C1 to C13.

3. A composition according to claim 1 wherein:
R¹ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen, or hydrogen;
R² and R³ which may be identical or different and which have the same definition as that given above for R¹ or which correspond to an alkoxy, an alkoxyalkyl, a benzyloxy, a cyano or an alkylcarbonyl;
R⁴ is an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxy, with a haloalkoxy, with an alkylthiol or with a halogen; a hydroxyl; a halogen; a cyano; an acyl;
m=0 or 1;
when it is present, R⁵ is a group having the same definition as that given above for R⁴,
A is a direct bond, —O—, —S—, —NR⁹—, —CHR⁷— or —O—CHR⁷—,
with R⁹, when it is present, corresponding to an alkyl, an alkenyl or an alkynyl, it being possible for each of these groups to be substituted with an alkoxy, a haloalkoxy, an alkylthiol, halogen or a phenyl optionally substituted with an alkyl, with a haloalkyl, with an alkoxyl, with a haloalkoxy, with an alkylthiol or with a halogen, or corresponds to hydrogen;
and R⁷ has the same definition as that given above for R⁹ or represents a hydroxyl; a halogen; a cyano; an acyl; alkoxy; a haloalkoxy or an alkylthiol;
A is linked to the 4-position of the benzyl ring M; and
R⁶ is a phenyl or an aromatic heterocycle, optionally substituted with one or more substituents, which may be identical or different, and which may be selected from the following list: hydroxyl; halogen; cyano; acyl; amine; alkylamine; dialkylamine; alkyl, haloalkyl, R^{a}O-alkyl, acyloxyalkyl, cyanooxyalkyl, alkoxy; haloalkoxy; alkylthiol; cycloalkyl (preferably cyclohexyl or cyclopentyl) optionally substituted with an alkyl, a haloalkyl, an alkoxy, a haloalkoxy or with an alkylthiol; and benzyl optionally substituted with an alkyl, a haloalkyl, an alkoxy, a haloalkoxy or with an alkylthiol.

4. A composition according to claim 1 wherein the following features are chosen independently or in combination:
R¹═H;
R²═C1-C6 alkyl;
R³═C1-C6 alkyl;
R⁴═C1-C6 alkyl;
R⁵═C1-C6 alkyl and R⁵ is linked to the carbon at C5 of the benzyl ring M, with m=1;
A is linked to the carbon at C4 of the benzyl ring M and represents —O—;
R⁶=aryl, optionally substituted with at least one alkyl and/or with at least one halogen.

5. A composition according to claim 1 wherein the following features are chosen independently or in combination:
R¹═H;
R²=methyl;
R³=ethyl;
R⁴=methyl;
R⁵=methyl and R⁵ is linked to the carbon at C5 of the benzyl ring M, with m=1;
A is linked to the carbon at C4 of the benzyl ring M and represents —O—;
R⁶=benzyl substituted with at least one alkyl and/or with at least one halogen.

6. A composition according to claim 1 wherein compound A is at least one of:
N-ethyl-N-methyl-N′-[4-(chloro-3-trifluoromethylphenoxy)-2,5-xylyl]-formamidine,
N-ethyl-N-methyl-N′-[4-(fluoro-3-trifluoromethylphenoxy)-2,5-xylyl]-formamidine,
N-ethyl-N-methyl-N′-[4-(3-t-butyl-4-chlorphenoxy)-2,5-xylyl]-formamidine, and/or an eventual tautomer and/or an addition salt with an acid or a base, which is agriculturally acceptable, of compound A.

7. A composition according to claim 1 wherein the weight ratio of the compounds A:B:C is comprised in the range from 1 part of A: 0.05-50 parts of B: 0.05-50 parts of C.

8. A composition according to claim 1 wherein the weight ratio of the compounds A:B:C is comprised in the range from 1 part of A: 0.02-20 parts of B: 0.02-20 parts of C.

9. A composition according to claim 1 wherein the weight ratio of the compounds A:B:C is comprised in the range from 1 part of A: 0.1-10 parts of B: 0.1-10 parts of C.

10. A method for curatively or preventively controlling the phytopathogenic fungi of a plant or crop comprising applying a fungicide composition according to claim 1 to a seed, a plant and/or to fruit of a plant and/or to soil in which a plant is growing or in which said plant is desired to grow.

11. A method according to claim 10 wherein propagation material is treated.

12. A method of claim 11 wherein said propagation material comprises a tuber, rhizome, seed, seedling or plant.
